(19) United States
(12) Patent Application Publication
(10) Pub. No.: US 2026/0252900 A1
(43) Pub. Date: Aug. 27, 2026

(54) Compiled Procedures for Artificial Intelligence Agents

(71) Applicant: ServiceNow, Inc., Santa Clara, CA (US)

(72) Inventors: Mohammed Furqan, Hyderabad (IN); Gaurav Goyal, Santa Clara, CA (US)

(21) Appl. No.: 19/065,068

(22) Filed: Feb. 27, 2025

(51) Int. Cl. G06N 3/092; G06N 3/045

(52) U.S. Cl. CPC G06N 3/092; G06N 3/045

(57) ABSTRACT

An embodiment may involve obtaining a template defining a virtual agent, wherein the template includes operational instructions of the virtual agent. The embodiment may also involve generating a representation of steps to be performed by the virtual agent based on the template. The embodiment may also involve obtaining a compiled virtual agent that is based on the representation of steps, wherein the compiled virtual agent is operable to perform the steps.

### BACKGROUND

Virtual agents can take the form of artificial intelligence (AI) powered conversational interfaces designed to interact with users and provide automated assistance. Virtual agents can be integrated into various interfaces and applications, such as web portals, chat interfaces, and messaging platforms to offer self-service options and enhance overall system efficiency.

Common problems affecting virtual agents driven by AI systems (e.g., an LLM) are performance and consistency. There is typically a linear relationship between the number of tokens an LLM generates and the amount of time and computing resources it takes for the LLM to generate these tokens. Further, a virtual agent performing a reasoning tasks (e.g., stepping through a problem or retrieving information from sources outside of an LLM) involves the generation of additional tokens, which in turn increases computational and time costs. Moreover, more tokens generated means slower performance, which also increases the time a user would wait for a virtual agent to produce a response to their query and thereby degrades the user experience.

Further, LLMs can be inconsistent. An LLM typically generates each part a response at runtime based on an associated query and context (e.g., past queries, etc.). However, due to variations in user inputs as well as the architecture of the LLM, virtual agent(s) using such models can produce inconsistent, non-deterministic, and/or unexpected results.

### SUMMARY

To address the problems described above, the approaches herein involve compiling AI-based virtual agents at design time, greatly improving both the performance and consistency of such agents.

A template is provided to an agent compiler system. The template may include a description of the agent’s function, specific instructions for tasks the agent should perform, and a listing of software tools the agent may be able to access on a user’s behalf. The agent compiler system may first map the information contained in the template to a series of discrete steps, which may include different paths the agent may take depending on user input or the result of a search. The generated result of the mapping process may exhibit some similarities to a list of discrete steps or decision tree architecture, depending on the application.

The generated result is provided to an LLM in order to produce a compiled agent. By providing precise instructions and discrete steps for the agent to follow, the consistency and reliability of the agent is improved. The performance of the agent is also improved by reducing the amount of tokens that are generated by the LLM during its reasoning processes. Reducing the amount of tokens in turn reduces the time it takes to run such agents and further reduces the utilization of computational resources (e.g., processor, memory, and/or power capacity) by the agent.

Accordingly, a first example embodiment may involve obtaining a template defining a virtual agent, wherein the template includes operational instructions of the virtual agent. The first example embodiment may also involve generating a representation of steps to be performed by the virtual agent based on the template. The first example embodiment may also involve obtaining a compiled virtual agent that is based on the representation of steps, wherein the compiled virtual agent is operable to perform the steps.

A second example embodiment may involve a computing system. The computing system may include one or more processors, as well as memory and program instructions. The program instructions may be stored in the memory, and upon execution by the at least one processor, cause the computing system to perform operations in accordance with the first example embodiment.

A third example embodiment may involve a non-transitory computer-readable medium, having stored thereon program instructions that, upon execution by a computing system, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a graph of LLM performance, in accordance with example embodiments.

FIG. 7A depicts a block diagram of an agent compiler, in accordance with example embodiments.

FIG. 7B depicts an agent template, in accordance with example embodiments.

FIG. 7C depicts a compiled output, in accordance with example embodiments.

FIG. 8A depicts an LLM reasoning output, in accordance with example embodiments.

FIG. 8B depicts a compiled agent reasoning output, in accordance with example embodiments.

FIG. 9A depicts test results, in accordance with example embodiments.

FIG. 9B depicts test results, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I.Example Technical Improvements

These embodiments provide a technical solution to a technical problem. As noted above, virtual agents, especially those that employ LLMs, can experience performance and consistency issues. There is a linear relationship between the amount of output tokens LLMs generate and the amount of time and computational resources it takes to generate these tokens. Further, if a virtual agent performs any “reasoning” tasks, such as stepping through a problem or retrieving information from a knowledge base (KB), the generation of such additional tokens would also add to generation time. In general, more tokens generated means slower performance, which also increases the time a user would wait for a virtual agent to produce a response to their query. In addition to slow response times, additional tokens would result in higher usage of computational resources (e.g., processor, memory, and/or power capacity).

The embodiments herein overcome these limitations by introducing a compiling process for LLM-based virtual agents. Such compiled agents are instructed using a set of specific instructions and/or steps that they follow during operations, and thus do not require the generation of as many reasoning tokens as they perform tasks. This greatly speeds up the operation of such agents through a more deterministic decision-making process, as well as reduces the use of computing resources such as memory through the reduction in the number of output tokens.

Other technical improvements may also flow from these embodiments, and other technical problems may be solved. Thus, this statement of technical improvements is not limiting and instead constitutes examples of advantages that can be realized from the embodiments.

### II.Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise’s ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise’s operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise’s custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise’s network and used to manage such a network. The following embodiments describe architectural and functional aspects of example aPaaS systems, as well as the features and advantages thereof.

### III.Example Computing Devices and Cloud-Based Computing Environments

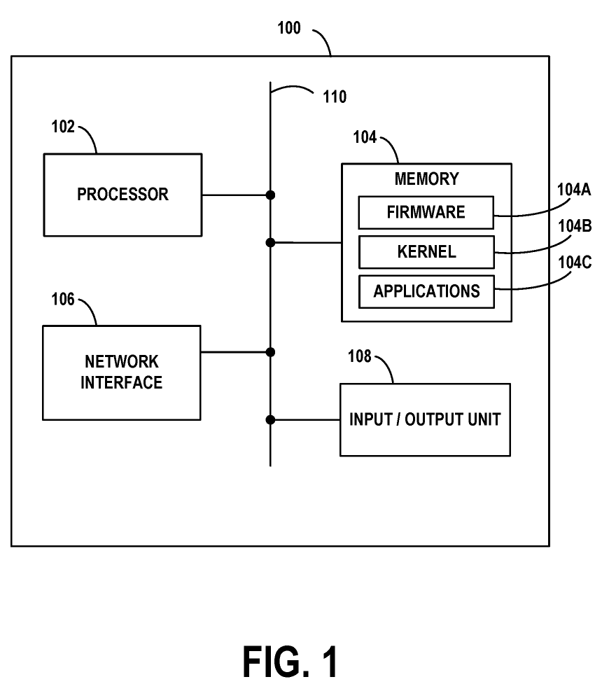

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input / output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input / output unit 108 may facilitate user and peripheral device interaction with computing device 100. Input / output unit 108 may include one or more types of input devices, such as a keyboard, a mouse, a touch screen, and so on. Similarly, input / output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

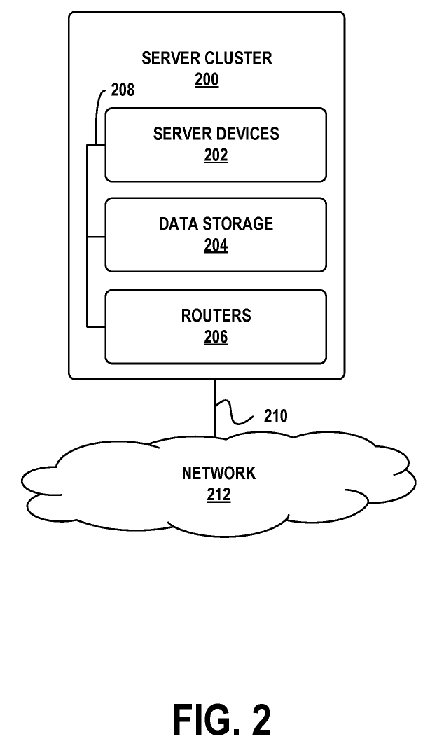

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV.Example Remote Network Management Architecture

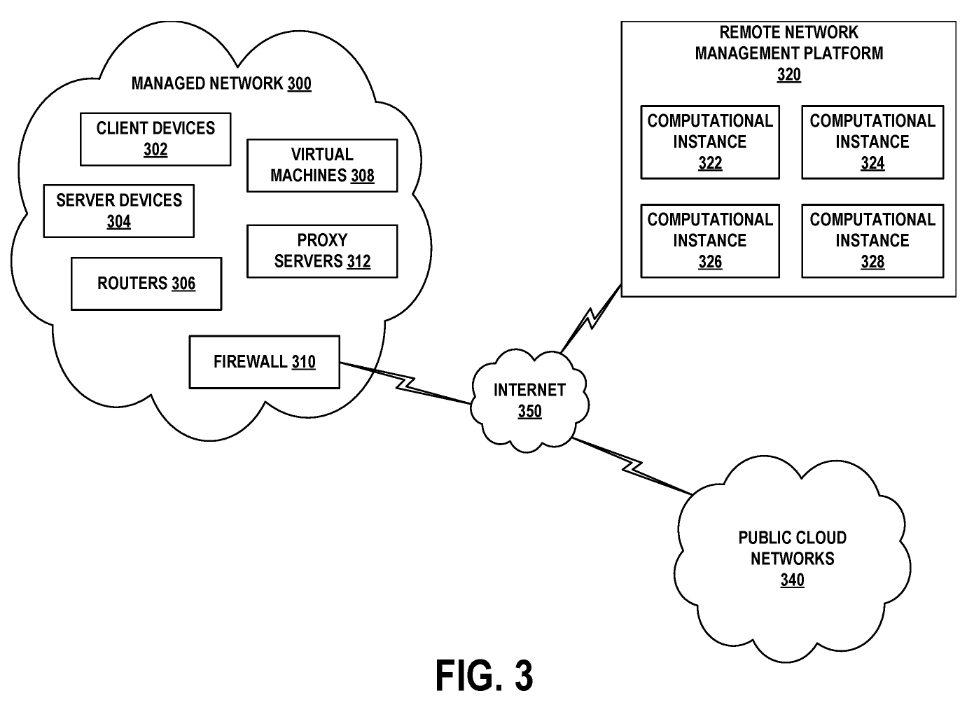

FIG. 3 depicts a remote network management architecture, in accordance with example embodiments. This architecture includes three main components – managed network 300, remote network management platform 320, and public cloud networks 340 – all connected by way of Internet 350.

### A.Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B.Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers’ data are separate from one another, the separation is enforced by the software that operates the single database. As a consequence, a security breach in this system may affect all customers’ data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer’s instance experiences an outage due to errors or an upgrade, other computational instances are not impacted. Maintenance down time is limited because the database only contains one customer’s data. Further, the simpler design of the multi-instance architecture allows redundant copies of each customer database and instance to be deployed in a geographically diverse fashion. This facilitates high availability, where the live version of the customer’s instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C.Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D.Communication Support and Other Operations

Internet 350 may represent a portion of the global Internet. However, Internet 350 may alternatively represent a different type of network, such as a private wide-area or local-area packet-switched network.

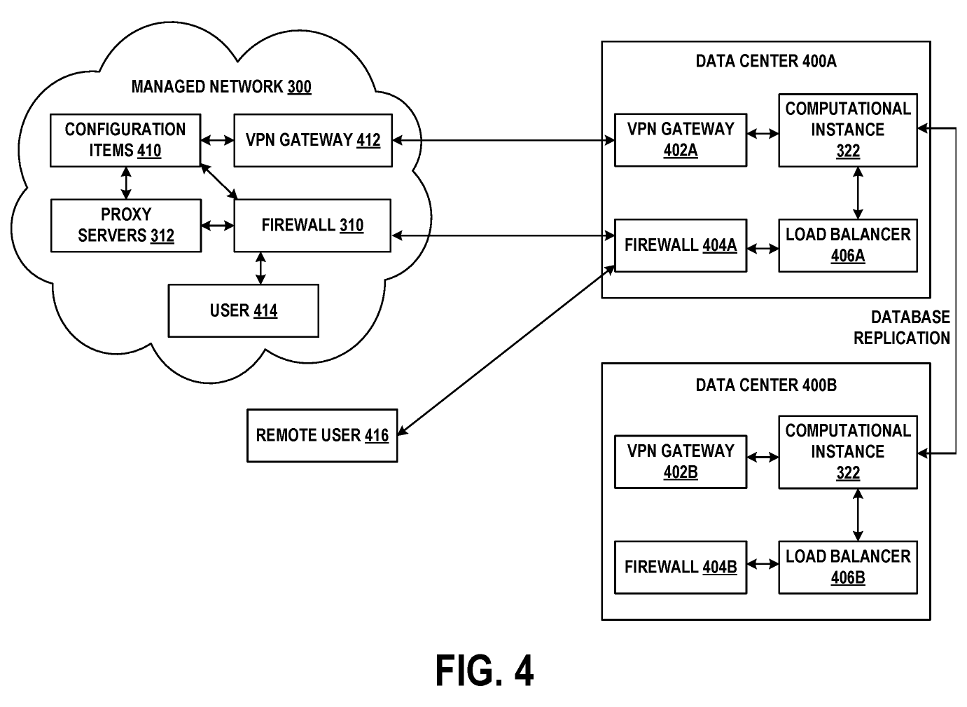

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0 – 10.255.255.255 or 192.168.0.0 – 192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V.Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

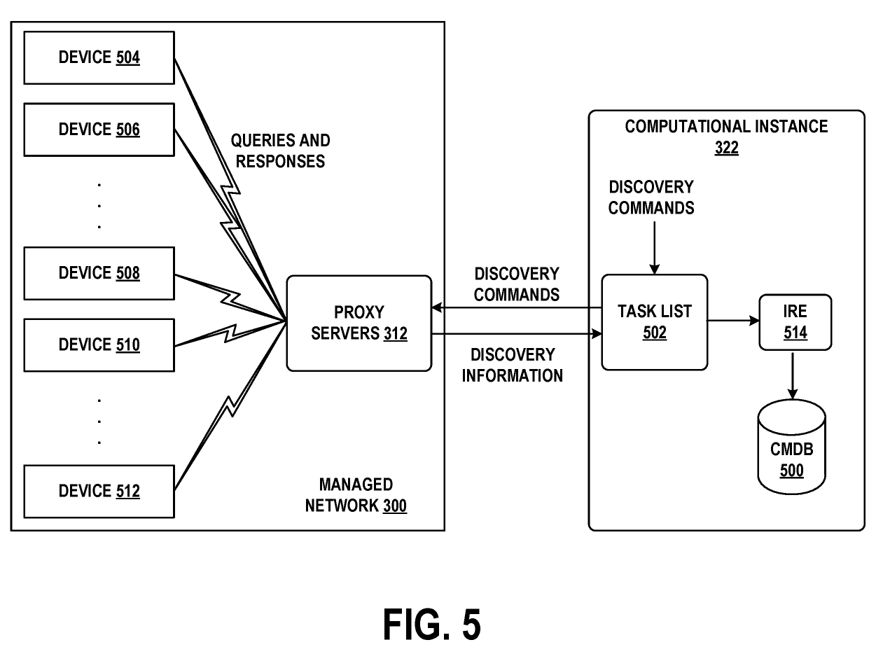

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid / password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery – horizontal and vertical (top-down). Each are discussed below.

### A.Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input / output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router’s network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases – under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B.Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices – for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C.Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI.CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item’s attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII.Example Platform Applications

As noted, remote network management platform 320 may support a number of applications and services, each of which may use or involve information from CMDB 500 and/or other databases as needed. Some of these applications and services may include task-based applications, workflows, user interface building tools, and agent interfaces, just to name a few. Other applications and services not explicitly discussed herein may benefit from the disclosed embodiments. Nonetheless, these task-based applications, workflows, user interface building tools, and agent interfaces are briefly described below to provide context for example embodiments of software that has user interfaces that could be enhanced by natural language model interactions.

### A.Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation / generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B.Workflows

As noted, task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow designer application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C.User Interface Building Tools

Remote network management platform 320 may provide a user interface builder application that is a visual design tool for creating and customizing user interfaces within the platform. This application may employ a low-code / no-code approach to designing intuitive graphical user interfaces, enabling administrators and developers to build user interface components without extensive coding knowledge.

Notably, low-code / no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through graphical interfaces, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D.Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 are different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a KB, which contains a repository of articles, frequently-asked questions (FAQs), and troubleshooting information. Virtual agents can access this KB to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user’s query or if the user requests human assistance, the conversation can be handed off to a live agent for further support and resolution. Such a handoff may involve providing, to the live agent, the context (and possibly some or all of the content) of the conversation between the user and the virtual agent.

### VIII.Example Compiled Agents

### A.Large Language Models (LLMs)

As discussed above, virtual agents may make use of LLMs. An LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM’s output and expected output.

An aspect of an LLM’s functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model’s ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### B.Performance and Consistency in LLMs

LLMs can also perform tasks through “reasoning”. For example, an LLM can decompose its reasoning into a series of structured logical steps through a process akin to chain-of-thought prompting, wherein intermediate inferential stages are explicitly articulated prior to generating a final response. Initially, the LLM engages in semantic parsing, identifying elements, contextual parameters, and constraints associated with the query. Subsequently, the LLM retrieves relevant knowledge by leveraging its trained parameters and/or from one or more external sources to approximate probabilistic associations within its latent space. The next stage involves logical inference, wherein the model establishes relationships, synthesizes retrieved knowledge, and deduces conclusions based on pattern recognition and prior training data. For problem-solving applications requiring sequential reasoning – such as mathematical computations, algorithmic execution, or structured argumentation – the LLM applies an iterative, stepwise approach to facilitate coherence and logical consistency. Once intermediate reasoning steps are completed, the LLM can synthesize its analysis into a final response, with the goal of being in alignment with the original query. Optionally, the LLM may engage in self-verification, employing internal consistency checks to refine, validate, or enhance its response by evaluating potential contradictions or errors.

In the absence of such reasoning, LLM results are often of a lower quality. Several factors can influence LLM output, such as user inputs or structural issues within the LLM itself. These factors can cause the LLM to deviate from an intended or expected path to solve a problem or generate a result. This can also result in inconsistencies between multiple operations of the same LLM using the same prompt. Thus, without a well-formed reasoning process, LLMs are less directed and can produce inconsistent, non-deterministic, and/or unexpected results.

However, asking an LLM to engages in reasoning requires that the LLM generate further output tokens in addition to the eventual result it reaches, increasing the time and computational resources the an LLM-based virtual agent uses to generate a completed output to a user. Further, if a LLM-based virtual agent performs other reasoning tasks, such as retrieving information from a KB, the generation of such additional tokens would also add to generation time. This issue can compound as more reasoning outputs are generated and referred to by the LLM in future responses.

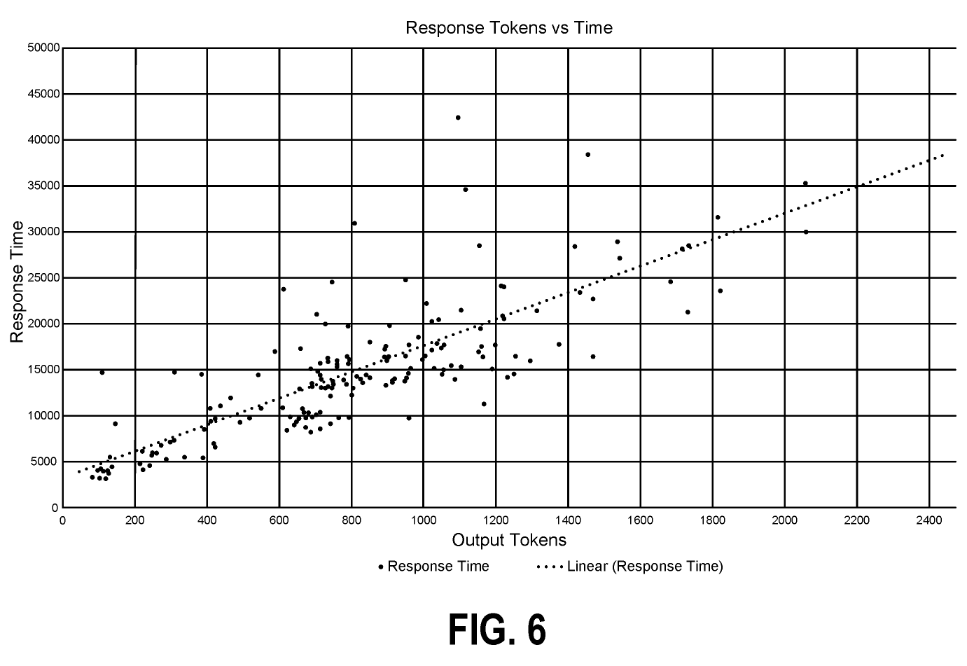

In general, there is a linear relationship between the amount of output tokens LLMs generate and the amount of time it takes to generate them. This relationship is depicted in FIG. 6. Thus, the additional overhead of an LLM explaining its reasoning results in slower performance, which also increases the time a user would wait for a virtual agent to produce a response to their query. This also can result in excessive consumption of limited computing resources such as processor, memory, and/or power capacity.

### C.Compiled Agents

To address the above-described performance and consistency issues, among others, “compiled agents” are described herein. Compiled agents are LLM-based virtual agents that avoid many of the shortfalls described above through specific instructions provided at the time of an agent’s creation, rather than when the agent is run.

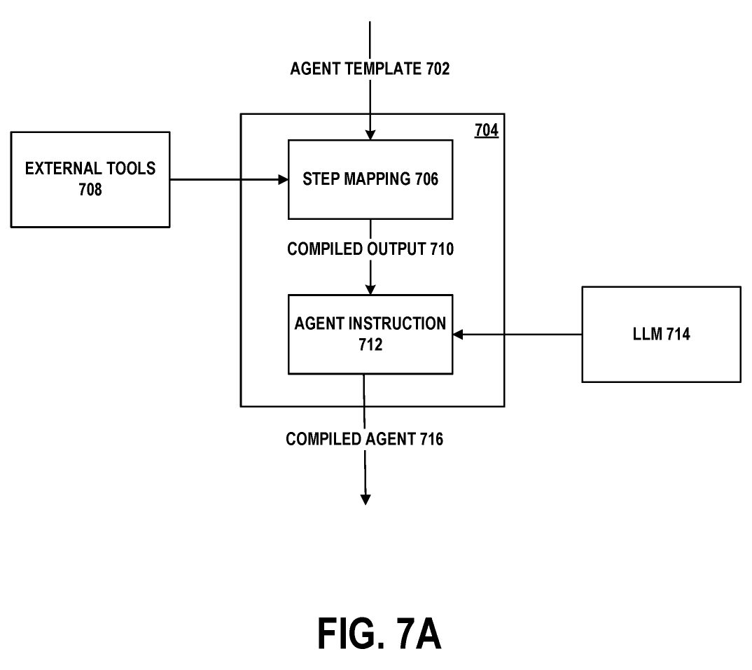

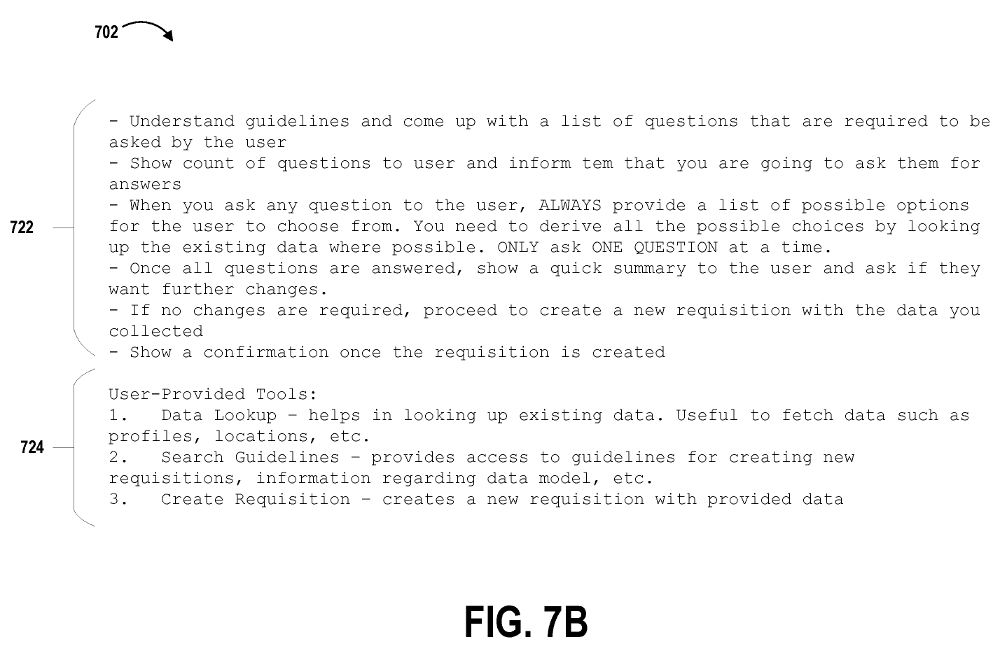

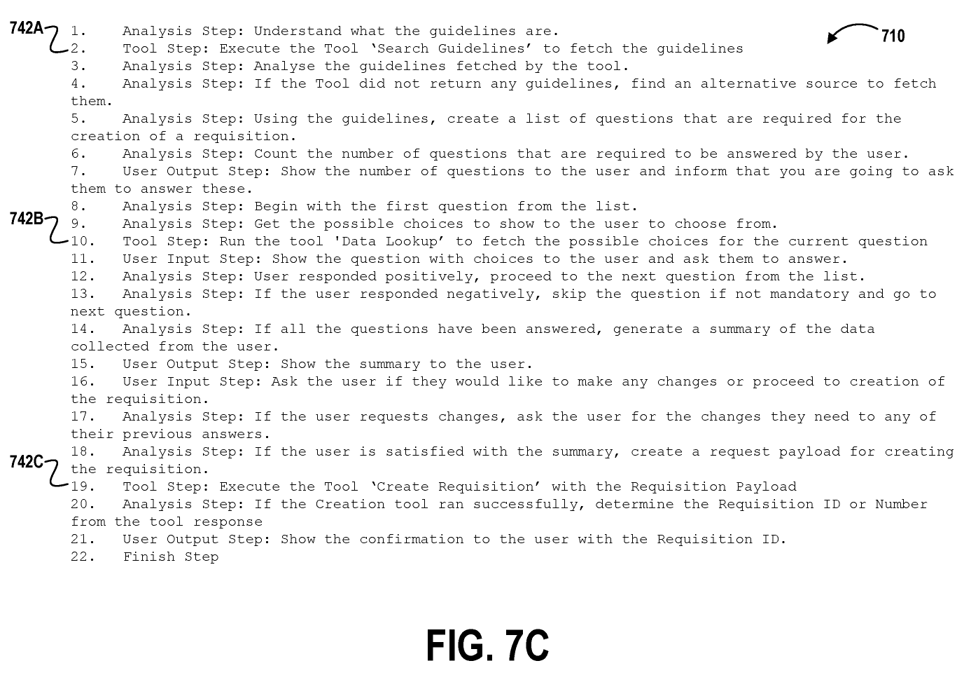

An overview of a compiling process for LLM-based virtual agents is depicted in FIG. 7A. An agent template 702 is provided to an agent compiling system 704. The agent template 702 may include a description of the agent’s function, specific instructions for tasks the agent should perform, and a listing of software tools or APIs (e.g., external tools 708) the agent may be able to access on a user’s behalf. Then, through step mapping 706, the agent compiling system 704 may map the information contained in the agent template 702 to a series of discrete steps.

The generated result of the mapping process, a compiled output 710, may be a text representation of a series of steps with reference to one another. In some examples, the compiled output 710 has some similarities to a decision tree architecture, as it may involve branching paths the agent may take depending on the situation. These steps are then provided to an LLM 714 as part of agent instruction 712 in order to produce a compiled agent 716. As part of this instruction process, the compiled agent 716 is instructed to follow the steps precisely, providing consistency and more deterministic behavior from the agent.

The performance of the agent is also improved by reducing the amount of tokens that are generated by the LLM during its “reasoning” processes, as rather than reasoning on its own the agent follows a pre-set series of steps. This has the effect of reducing the time it takes to run such agents and further reducing the amount of memory and computational resources consumed by the agent.

The above process shown in FIG. 7A will now be discussed in further detail with reference to FIGS. 7B and 7C.

An example agent template 702 is depicted in FIG. 7B. In this example, the agent template 702 includes task-specific instructions 722 and a tools listing 724 relating to user interactions and the creation of requisitions. While the agent template 702 is depicted in plain text, in some situations the agent template 702 may be encoded in plain text, eXtensible Markup Language, JavaScript Object Notation, HyperText Markup Language, or Yet Another Markup Language.

One benefit of the agent template 702 is that it functions as a “blueprint” for the eventual compiled agent. Thus, even in certain deployments, users may modify the agent template 702 according to their wishes, providing flexibility that a more general-purpose LLM may not be able to provide. In some situations, the agent template 702 may be selected from a plurality of templates. In some situations, the agent template 702 may be provided by a user.

The agent template 702 is then provided to an agent compiling system 704. The agent compiling system 704 may include an LLM and/or other processing elements. The agent compiling system 704 takes as input the agent template 702, which then undergoes step mapping 706.

Step mapping 706 uses the information in the agent template 702 to map the task-specific instructions 722 to a series of discrete steps. Such steps may be of different types. For instance, a "thinking” step may be generated as part of step mapping when the agent performs analysis, while a “tool” step may involve the agent accessing one or more external tools 708, such as a KB or creation task, on the user’s behalf. Other example steps may involve receiving input from a user (a “user input” step) or conversely displaying some output for a user’s review (a “user output” step).

In order to provide deterministic operations of the agent, each instruction in the agent template 702 may be mapped to a step as part of step mapping 706. For a “tool” step, step mapping 706 may use the tools listing 724 to link the agent to one or more external tools 708, as above. In some situations, a natural language model (e.g., an LLM) may perform step mapping 706. The output of step mapping 706 is a compiled output 710.

FIG. 7C depicts an example compiled output 710. As shown, the information within the agent template 702 has been mapped into a series of twenty-two discrete steps, primarily of the “analysis” and “tool” types described above. For the “tool” steps 742A, 742B, and 742C, the steps are linked to the “Search Guidelines,” “Data Lookup,” and “Create Requisition” tools, respectively, of the tools in the tools listing 724 of the agent template 702. This tool linking (or tool association) process enables the agent to interact with other programs and components outside of user interactions, further allowing them to perform more complex tasks. Some other examples of external tools 708 include a database search tool or a data entry tool.

The steps within the compiled output 710 may refer back to one another (or otherwise be associated with other steps) in case information inputted or retrieve during a previous step is used by the agent for a task in a later step. However, rather than all of this context information being retained as part of an LLM’s prompt, as would be the case in some approaches and which increases the amount of tokens and thus runtime, the information is associated with a particular step (and step number) that may be retrieved if needed. This has the effect of reducing the time it takes to run such agents and further reducing the amount of memory and computational resources consumed by the agent. Such references between steps may also allow for more efficient transitions between steps when the agent is operating.

In some examples, the compiled output 710 has some similarities to a decision tree architecture, as it may involve branching paths the agent may take depending on the situation. For instance, a “user input” step may result in a user providing a yes or no response, and the agent may take different actions or proceed to a different step depending on the response. In other words, the virtual agent may receive, from a user via a user interface, a text input, process the text input, perform a further step within the representation of steps based on the text input, and output, via the user interface, a text output. In some situations, processing the text input includes selecting the further step from the representation of steps based on the text input.

The compiled output 710 is then provided to agent instruction 712 in order to produce a compiled agent 716. As part of this process, an LLM 714 is instructed (through the use of specific prompts such as system prompts or other methods) to adhere to the steps of the compiled output 710, providing consistency and more deterministic behavior from the agent. This process is referred to as “compiling” as the instructions are provided to the compiled agent 716 at the time the agent is created, rather than at runtime, similar to how program code (in programming languages such as C) is compiled when a program is built.

This also results in improved performance, as will be demonstrated below. After agent instruction 712, the LLM 714 becomes the compiled agent 716, which may then be deployed as a virtual agent in the situations described above. For instance, the compiled agent 716 may be deployed as part of a remote network management platform, as described above.

In some embodiments, the LLM 714 may be an LLM as described above or another type of natural language model and/or a transformer-based language model.

### D.Performance of Compiled Agents

This section analyzes the performance of compiled agents against other approaches to LLM reasoning tasks.

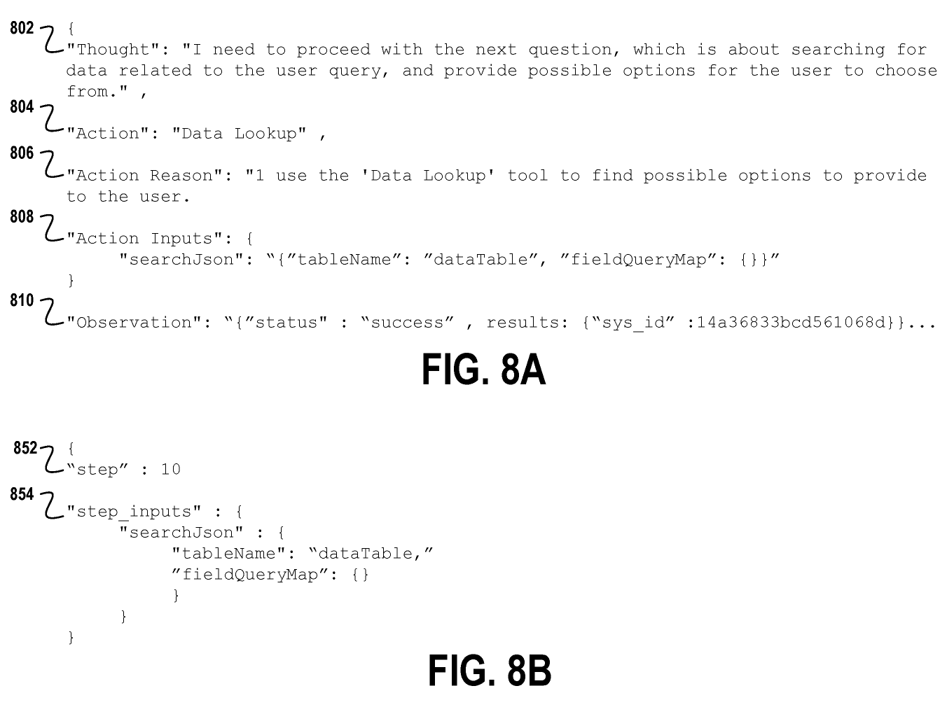

ReAct is one framework that enables LLMs to explain their own reasoning when performing tasks. An example of a reasoning output from ReAct (in JSON format) is depicted in FIG. 8A. As shown, an LLM responds to a user query that necessitates a data lookup task, and the output includes a thought 802, action 804, action reasoning 806, action inputs 808, and observation 810. Such a response would be around 200 LLM tokens in length. Some LLM calls in a similar fashion that generate reasoning for output can produce responses of over 500 LLM tokens in length, which can take over ten seconds for a single API call to the LLM.

FIG. 8B depicts the equivalent reasoning output for a compiled agent as described herein. As shown, the agent’s reasoning response contains two components: a step 852 and step inputs 854. The step 852 corresponds to the step of the compiled output 710 that the compiled agent is following, in this case step 10, which runs the “Data Lookup” tool using the step inputs 854. This response would generally be around 30-50 LLM tokens in length. In some embodiments, the reasoning response may contain multiple steps, representing a diverging path that the compiled agent may take depending on the result of an action or after receiving user input.

This comparison of outputs demonstrates that compiled agents greatly reduce the amount of tokens required for similar reasoning tasks performed by LLMs. This is accomplished by eliminating the thought 802, action reason 806, and observation 810 items, in which ReAct essentially talks itself through its task. These items would be part of the LLM’s inputs for future tasks and queries, further increasing the amount of tokens it would need to handle. This would further consume computing resources and slow down the performance of the LLM. In contrast, the compiled agent simply performs the data lookup task associated with the step 852 as directed by the compiled output 710, and achieves the same result of data lookup.

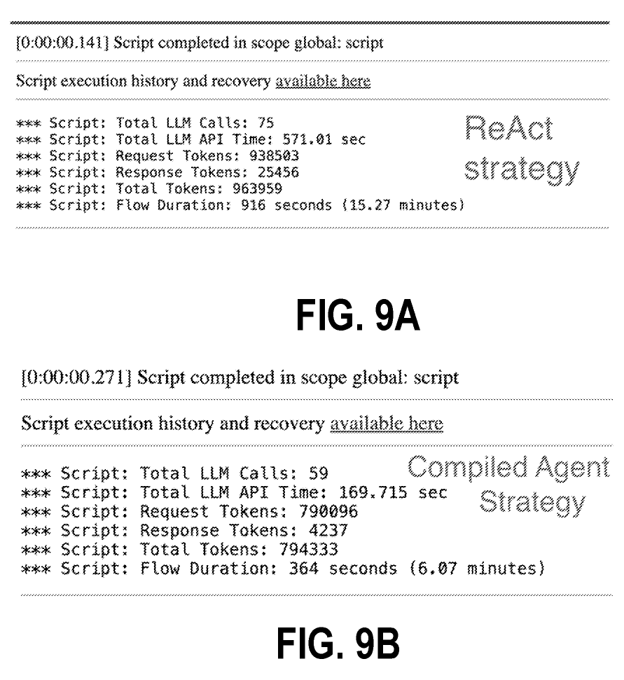

FIG. 9A depicts test results from running a test script using the ReAct framework. FIG. 9B depicts test results from running the same test script using compiled agents as described herein.

These results demonstrate that compiled agents have greatly improved performance for the same results versus other approaches. Taken as a whole, compiled agents provide over 3x faster API time, 2.5x faster overall duration, and a 6x reduction in response tokens in comparison to ReAct. This further demonstrates that compiled agents, as described herein, present a technical improvement in the field of LLMs and AI systems as whole by speeding up computation and reducing the use of limited computing resources such as processor, memory, and/or power capacity.

### IX.Example Operations

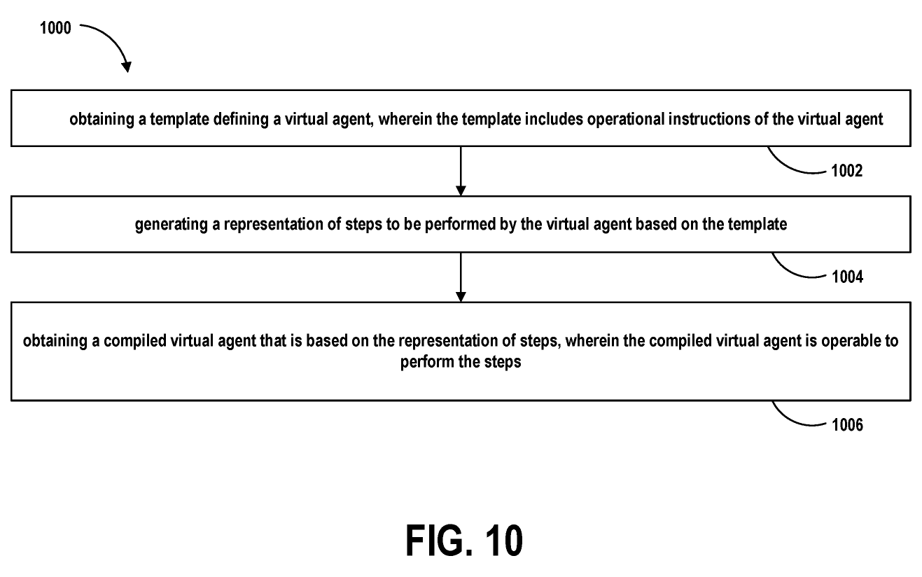

FIG. 10 is a flow chart illustrating an example embodiment. The process 1000 illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1002 may involve obtaining a template defining a virtual agent, wherein the template includes operational instructions of the virtual agent.

Block 1004 may involve generating a representation of steps to be performed by the virtual agent based on the template.

Block 1006 may involve obtaining a compiled virtual agent that is based on the representation of steps, wherein the compiled virtual agent is operable to perform the steps.

This step represents a technical improvement, as by providing precise instructions and discrete steps for the agent to follow, the consistency and reliability of the agent is improved. The performance of the agent is also improved by reducing the amount of tokens that are generated by the LLM during its reasoning processes. Reducing the amount of tokens in turn reduces the time it takes to run such agents and further reduces the utilization of computational resources (e.g., processor, memory, and/or power capacity) by the agent.

In some embodiments, the compiled virtual agent is based on a natural language model as instructed with the representation of steps. In some embodiments, the natural language model is a transformer-based language model.

In some embodiments, obtaining the compiled virtual agent includes performing a compiling operation based on the representation of steps to generate the compiled virtual agent. In some embodiments, performing the compiling operation involves instructing the virtual agent to adhere to the representation of steps when performing the steps.

In some embodiments, the template defining the virtual agent is encoded in plain text, eXtensible Markup Language, JavaScript Object Notation, HyperText Markup Language, or Yet Another Markup Language.

In some embodiments, the operational instructions of the virtual agent include instructions relating to accessing one or more software tools external to the virtual agent. In some embodiments, the software tools include a database search tool or a data entry tool. In some embodiments, the virtual agent is configured to access the one or more software tools using an application programming interface (API).

In some embodiments, the representation of steps includes a numbered list of steps, wherein each step in the numbered list of steps is associated with at least one other step within the numbered list of steps such that the virtual agent is configured to proceed from one step to another in a specified order.

In some embodiments, the representation of steps includes one or more steps that instruct the virtual agent to: receive, from a user via a user interface, a text input, process the text input, perform a further step within the representation of steps based on the text input, and output, via the user interface, a text output. In some embodiments, processing the text input includes selecting the further step from the representation of steps based on the text input.

In some embodiments, the representation of steps is generated by a further natural language model.

In some embodiments, obtaining the template defining the virtual agent comprises selecting the template defining the virtual agent from a plurality of templates.

In some embodiments, obtaining the template defining the virtual agent comprises receiving, from a user via a user interface, the template.

In some embodiments, the process 1000 may further include deploying the compiled virtual agent as part of a web-based remote network management platform.

### X.Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

What is claimed is:

1. A method comprising:
obtaining a template defining a virtual agent, wherein the template includes operational instructions of the virtual agent;
generating a representation of steps to be performed by the virtual agent based on the template; and
obtaining a compiled virtual agent that is based on the representation of steps, wherein the compiled virtual agent is operable to perform the steps.

2. The method of claim 1, wherein the compiled virtual agent is based on a natural language model as instructed with the representation of steps.

3. The method of claim 2, wherein the natural language model is a transformer-based language model.

4. The method of claim 1, wherein obtaining the compiled virtual agent includes performing a compiling operation based on the representation of steps to generate the compiled virtual agent.

5. The method of claim 4, wherein performing the compiling operation comprises instructing the virtual agent to adhere to the representation of steps when performing the steps.

6. The method of claim 1, wherein the template defining the virtual agent is encoded in plain text, eXtensible Markup Language, JavaScript Object Notation, HyperText Markup Language, or Yet Another Markup Language.

7. The method of claim 1, wherein the operational instructions of the virtual agent comprise instructions relating to accessing one or more software tools external to the virtual agent.

8. The method of claim 7, wherein the software tools include a database search tool or a data entry tool.

9. The method of claim 7, wherein the virtual agent is configured to access the one or more software tools using an application programming interface (API).

10. The method of claim 1, wherein the representation of steps comprises a numbered list of steps, wherein each step in the numbered list of steps is associated with at least one other step within the numbered list of steps such that the virtual agent is configured to proceed from one step to another in a specified order.

11. The method of claim 1, wherein the representation of steps includes one or more steps that instruct the virtual agent to:
receive, from a user via a user interface, a text input;
process the text input;
perform a further step within the representation of steps based on the text input; and
output, via the user interface, a text output.

12. The method of claim 11, wherein processing the text input comprises selecting the further step from the representation of steps based on the text input.

13. The method of claim 1, wherein the representation of steps is generated by a further natural language model.

14. The method of claim 1, wherein obtaining the template defining the virtual agent comprises selecting the template defining the virtual agent from a plurality of templates.

15. The method of claim 1, wherein obtaining the template defining the virtual agent comprises receiving, from a user via a user interface, the template.

16. The method of claim 1, further comprising deploying the compiled virtual agent as part of a web-based remote network management platform.

17. A computing system comprising:
one or more processors;
memory; and
program instructions, stored in the memory, that, upon execution by the one or more processors, cause the one or more processors to perform operations comprising:
obtaining a template defining a virtual agent, wherein the template includes operational instructions of the virtual agent;
generating a representation of steps to be performed by the virtual agent based on the template; and
obtaining a compiled virtual agent that is based on the representation of steps, wherein the compiled virtual agent is operable to perform the steps.

18. The computing system of claim 17, wherein the compiled virtual agent is based on a natural language model as instructed with the representation of steps.

19. A non-transitory computer-readable medium, storing program instructions that, when executed by one or more processors of a computing system, cause the one or more processors to perform operations comprising:
obtaining a template defining a virtual agent, wherein the template includes operational instructions of the virtual agent;
generating a representation of steps to be performed by the virtual agent based on the template; and
obtaining a compiled virtual agent that is based on the representation of steps, wherein the compiled virtual agent is operable to perform the steps.

20. The non-transitory computer-readable medium of claim 19, wherein the compiled virtual agent is based on a natural language model as instructed with the representation of steps.
